(19) United States
(12) Patent Application Publication
(10) Pub. No.: US 2012/0206062 A1
(43) Pub. Date: Aug. 16, 2012

(54) TIME-DOMAIN REDUCTION OF FLICKER AND POWER CONSUMPTION IN LED LIGHTING

(76) Inventor: Scott Riesebosch, St. Catharines (CA)

(21) Appl. No.: 13/024,584

(22) Filed: Feb. 10, 2011

(51) Int. Cl. H05B 37/02

(52) U.S. Cl. 315/291

(57) ABSTRACT

In accordance with certain embodiments, a power signal for driving an LED lighting system is analyzed on a timeslice basis, and the signal is adjusted (e.g., on a timeslice basis) to compensate for deviations therein.

### FIELD OF THE INVENTION

In various embodiments, the present invention generally relates to light-emitting-diode-based lighting systems and improvements to the performance and quality of light emitted from such systems.

### BACKGROUND

The popularity of lighting systems based on light-emitting diodes (LEDs, such systems also referred to herein as “LED lamps” or “LED fixtures”) as replacements for traditional light sources continues to grow. One of the many challenges in designing replacement LED lamps is making them behave like the light sources they are replacing, despite their underlying differences; users may be reluctant to use an LED lamp if the light it provides is significantly different from, for example, light from an incandescent bulb. LED lamps tend to react more quickly to changes in input voltage because LEDs have a faster response time than, e.g., a filament in an incandescent bulb. This fast response time can be a detriment in LED lamps when, for example, they are exposed to noisy power supplies; small deviations in power signal strength or rise/fall times (i.e., “jitter”), to which traditional light sources are too slow to react, may produce visible flicker in LED lamps.

Flicker can be a by-product of the design of traditional LED lamps, which mimic resistors during operation in order to boost their power factor (i.e., the ratio of the real power flowing to a load to the apparent power in a circuit, as known in the art). Thus, in such products, as the input voltage rises, the input current rises concomitantly. However, such behavior can lead to LED lamps not drawing sufficient current during periods of low input voltage, as well as drawing more current than is sufficient (or optimal) during periods of high input voltage. Thus, visible flicker and excessive energy consumption, respectively, can result during operation of traditional LED lamps, especially when exposed to input-signal noise. Since LED lamps are generally powered by alternating current (AC), the aforementioned problems cannot be solved concurrently via boosting or reducing the magnitude of the entire input-power waveform, as improvements in flicker reduction during a portion of the waveform period will exacerbate the power-consumption problem during another portion, and vice versa. A need therefore exists for systems and methods that reconcile these two concurrent issues with LED-lamp operation.

### SUMMARY

In accordance with certain embodiments, systems and methods described herein divide the waveform of, e.g., the input current supplied to an LED lamp, into a plurality of timeslices (i.e., portions of the signal in the time domain) and, for each timeslice, adjust (i.e., increase or decrease) the current to compensate for any deviation from a desired waveform. This “timeslicing” of the input signal enables flicker and energy consumption to be reduced concurrently, as different portions of each waveform period may be adjusted differently (or not at all, as some timeslices may not deviate from the desired waveform, at least not more than a threshold amount). The adjustments are preferably no greater in magnitude than required to, e.g., reduce or prevent flicker and/or excessive energy consumption.

The series of adjustments may be stored and associated with a particular LED lamp or type of LED lamp as a pedigree. The adjustment profile thus created may be utilized in connection with the lamp (or other lamps of its type) rather than (or in conjunction with or as a starting point for) the above-described dynamic adjustments to the input signal.

In an aspect, embodiments of the invention feature a method for driving an LED lighting system. A power signal (e.g., an input signal) is divided into timeslices, and, for each timeslice, a deviation in the power signal relative to an expected value (if any) is detected. The power signal is adjusted based at least in part on detected deviations, and an LED lighting system is driven with the adjusted signal.

Embodiments of the invention may include one or more of the following features, in any of a variety of combinations. Adjusting the power signal may include or consist essentially of adjusting the power signal at each timeslice where a deviation is detected, to substantially compensate for the deviation. Any deviation may be compared to a threshold deviation for one or more timeslices, or even each timeslice. The power signal may be adjusted to substantially compensate for the deviation only if the deviation is greater than the threshold deviation for one or more timeslices, or even each timeslice. The expected values over a plurality of timeslices may correspond to a desired waveform. The desired waveform may be determined by averaging a plurality of cycles of the power signal. The desired waveform may be determined by (i) determining a type of the LED lighting system, and (ii) obtaining, from a look-up table, the desired waveform cross-referenced to the type of the LED lighting system. The desired waveform may be determined by (i) monitoring an effect of the output signal on the LED lighting system, and (ii) adjusting the desired waveform based on the effect. The power signal may be an AC current.

The adjusted signal may be divided into timeslices. For one or more timeslices, or even each timeslice, the method may include (i) detecting whether a deviation exists in the adjusted signal relative to an expected value, and (ii) adjusting the adjusted signal during at least one subsequent timeslice based at least in part on detected deviations. The power signal may be dimmed, e.g., prior to dividing the power signal into timeslices. Dimmer-setting data related to the dimmed power signal may be stored. The power signal may be adjusted based in part on the dimmer-setting data. Adjustment data related to a selected cycle (or cycles) of the power signal may be stored. Adjusting the power signal may include or consist essentially of adjusting at least one cycle of the power signal after the selected cycle(s) based at least in part on the adjustment data.

In another aspect, embodiments of the invention feature a circuit for driving an LED lighting system that includes or consists essentially of (i) a detection circuit for detecting deviations in a power signal compared to a desired waveform on a timeslice basis, and (ii) an adjustment circuit for adjusting the power signal based at least in part on detected deviations in the power signal. The adjustment circuit may adjust the power signal at one or more timeslices, or even each timeslice, where a deviation is detected to substantially compensate for the deviation.

Embodiments of the invention may include one or more of the following features, in any of a variety of combinations. The circuit may include a driver circuit for converting the adjusted power signal into an output signal suitable for driving the LED lighting system. The circuit may include (i) a second detection circuit for detecting deviations in the output signal compared to an expected power on a timeslice basis, and (ii) a second adjustment circuit for adjusting the output signal based at least in part on detected deviations in the output signal. When a deviation in the output signal is detected during a first timeslice, the second adjustment circuit may adjust the output signal during at least one subsequent timeslice subsequent to the first timeslice (e.g., within the same cycle of the output signal). The circuit may include a dimmer for dimming the power signal. The circuit may include a storage module for storing the desired waveform, storing historical adjustments to previous cycles of the power signal, storing dimmer-setting data, and/or storing power-signal history. The adjustment circuit may adjust the power signal based at least in part on the historical adjustments. The circuit may include a transformer and/or a rectifier for producing the power signal.

These and other objects, along with advantages and features of the invention, will become more apparent through reference to the following description, the accompanying drawings, and the claims. Furthermore, it is to be understood that the features of the various embodiments described herein are not mutually exclusive and can exist in various combinations and permutations. As used herein, the term “substantially” means±10%, and in some embodiments, ±5%.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a block diagram of an LED lighting system in accordance with various embodiments of the invention;

FIG. 2A compares an unprocessed series of waveforms with a desired waveform in accordance with various embodiments of the invention;

FIG. 2B graphically illustrates the series of waveforms from FIG. 2A after processing in accordance with various embodiments of the invention;

FIG. 3A graphically illustrates a series of unprocessed output waveforms in accordance with various embodiments of the invention;

FIG. 3B graphically illustrates the series of waveforms from FIG. 3A after processing in accordance with various embodiments of the invention; and

FIG. 4 is a flowchart illustrating a method of adjusting the input and/or output signals of an LED driver on a timeslice basis in accordance with various embodiments of the invention.

### DETAILED DESCRIPTION

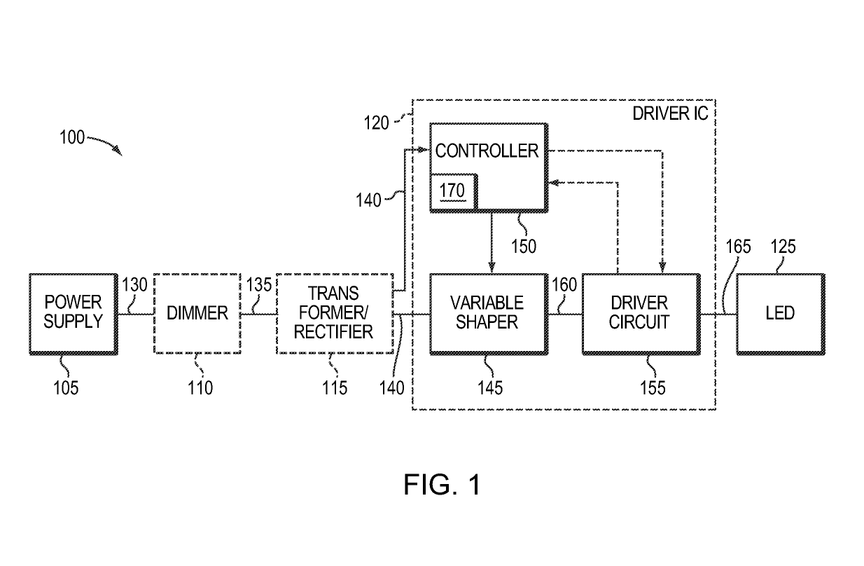

With reference to FIG. 1, an LED lighting system 100 in accordance with various embodiments of the present invention includes a power supply 105, an optional dimmer 110, an optional transformer 115, a driver integrated circuit (IC) 120, and one or more LEDs 125. Herein, references to LED 125 are understood to include single LEDs, groups of interconnected LEDs, and LED-based lighting modules (e.g., replacement bulbs). The power supply 105, for example an AC mains supply, provides an AC power signal 130. (As utilized herein, an AC signal may alternate relative to a zero point or a direct-current (DC) bias). The dimmer 110 may be used to alter a power level of the AC power signal 130 and provide a dimmed AC signal 135. The transformer 115 may be used to change the magnitude, frequency, and/or polarity of the AC power signal 130 or the dimmed AC signal 135, resulting in input signal 140. The transformer may be a magnetic, electronic, or any other type of transformer. The transformer 115 may be supplemented with or replaced by a rectifier that produces input signal 140 for the lighting system 100.

The driver IC 120 converts input signal 140 into a form suitable for driving the LED 125 while also selectively adjusting it, to minimize or prevent flicker and excessive energy consumption. While the input signal 140 (and/or other signals described herein) is preferably adjusted on a timeslice basis, it may alternatively be adjusted on an analog basis (e.g., over one or more timeslices, cycles, or half-cycles) based at least in part on the timeslice analysis. As shown in FIG. 1, driver IC 120 may include or consist essentially of a variable shaper 145, a controller 150, and a driver circuit 155. As described below in more detail, shaper 145 adjusts, on a timeslice basis, input signal 140 in response to commands from controller 150, resulting in shaped signal 160. Controller 150 monitors input signal 140, divides it up into timeslices, compares input signal 140 (on a timeslice basis) to a desired waveform suitable to power LED 125 with little or no flicker and excess energy consumption, and sends commands to shaper 145 to compensate for the deviations (again on a timeslice basis). Driver circuit 155 converts shaped signal 160 into an output signal 165 suitable for driving LED 125. For example, output signal 165 is typically a DC or modulated DC signal. Other components and features, such as a DC-to-DC converter or ballast, may be included in the driver IC 120. Furthermore, the arrangement of the components in the system 100 is not intended to be limiting, and other arrangements and combinations are within the scope of the invention. For example, transformer 115 may be included within driver IC 120. Furthermore, as mentioned above, the dimmer 110 may not be present, and the transformer 115 may not be present or may be replaced by a rectifier.

In various embodiments, controller 150 contains a storage module 170 for storing historical information regarding input signal 140, output signal 165, deviations in either signal, and/or one or more patterns of timeslice-basis adjustments (i.e., adjustment profiles) to either signal. Storage module 170 may also store information regarding a specific LED 125 and/or its type (e.g., brand and/or model) and one or more adjustment profiles associated therewith. The storage module 170 may be any storage medium known in the art, such as flash memory, standard RAM and/or ROM, solid-state memory, or any other kind of volatile or non-volatile memory. In one embodiment, a nonvolatile storage medium is used to retain history information when the LED 125 is powered off; in another embodiment, the storage medium includes or consists essentially of volatile memory and new history information is collected each time the LED 125 is powered on.

As signified by the dashed lines between controller 150 and driver circuit 155 (and as described in more detail below), controller 150 may also monitor output signal 165 in order to (i) make adjustments to the desired waveform based thereon, and/or (ii) detect a power deviation in a timeslice of output signal 165 and issue commands to modify the current of any or all of the remaining timeslices of that particular cycle (i.e., period) of output signal 165 accordingly.

Controller 150 may digitally sample the input signal 140 and/or the output signal 165, or may determine the characteristics thereof during a particular timeslice using analog components. The controller 150 may include a processor, microprocessor, application-specific integrated circuit, field-programmable grid array, or any other type of digital logic circuit programmed to implement the functions described above. The program may be written in any of a number of high-level languages, such as FORTRAN, PASCAL, C, C++, C#, Java, Tcl, or BASIC. Further, the program can be written in a script, macro, or functionality embedded in commercially available software, such as EXCEL or VISUAL BASIC. Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, computer-readable media such as a floppy disk, a hard disk, an optical disk, a magnetic tape, a ROM or PROM, an EPROM, a CD-ROM, or DVD-ROM.

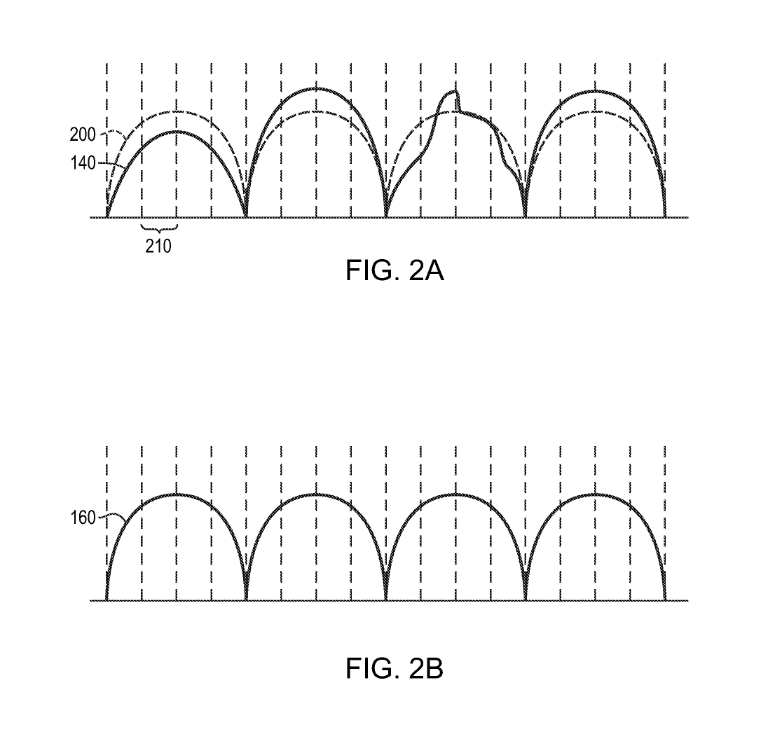

FIG. 2A depicts a series of waveforms from an exemplary input signal 140 compared with a desired waveform 200. Input signal 140 may include or consist essentially of, e.g., an input current. Input signal 140 is divided into a series of timeslices 210; in particular, each cycle or half-cycle of input signal 140 may be divided into two or more timeslices 210, with a greater number of timeslices 210 enabling adjustment of the signal with greater granularity. Although particular numbers of timeslices are shown in the figures, and those timeslices are depicted as approximately evenly distributed as a function of time, embodiments of the invention may contain any number of timeslices, and those timeslices are not necessarily evenly distributed (as a function of time) within a waveform cycle or half-cycle.

As shown, input signal 140 may deviate from desired waveform 200 due to, e.g., noise such as static AC noise, and during each timeslice 210, may have a current level lower than that of desired waveform 200 (thus risking or causing flicker), higher than that of desired waveform 200 (thus resulting in excessive energy consumption, or approximately (e.g., within a tolerable deviation) equal to that of desired waveform 200 (thus not necessitating adjustment). And, any combination of these conditions may occur in a single cycle or half-cycle of input signal 140.

The deviations in the input signal 140, as one of skill in the art will understand, may come from any number of sources. The voltage or current produced by the power supply 105 may fluctuate if, for example, another load proximate the LED 125 is suddenly switched on or off. Nearby electrical systems may emit electromagnetic radiation that may couple to, and induce noise in, any of the components or wiring depicted in FIG. 1. Those components themselves may produce noise due to, for example, manufacturing defects and component mismatches. For example, the dimmer 110 and/or the transformer 115 may engage or “fire” at less-than-ideal times (i.e., sooner or later than intended) and thereby introduce noise into the signal.

The desired waveform 200 generally corresponds to a signal for operating LED 125 without visible flicker and without excessive energy consumption, e.g., a current level sufficient to prevent flicker but not so large as to result in more energy consumption than necessary for operation of LED 125. The desired waveform 200 may be predetermined and stored in controller 150 (e.g., within storage module 170), or may be determined dynamically by driver IC 120. For example, controller 150 may monitor a specified number of cycles of input signal 140 (e.g., approximately 1000 cycles) and average them to determine the desired waveform 200. Alternatively, controller 150 may determine the type of LED 125 to which driver IC 120 is connected (by, e.g., application of a test voltage thereto and analysis of a characteristic current response to the test voltage) and obtain the desired waveform 200 from a stored look-up table containing one or more desired waveforms cross-referenced to specific LEDs 125 and/or types of LEDs 125. Controller 150 may even utilize a generic baseline desired waveform 200 and adjust it dynamically via monitoring of the output signal 165. For example, if the DC current level of output signal 165 is below a threshold level at which flicker results (or if the “off” period of a modulated DC signal is large enough for flicker to result), controller 150 may adjust (by raising the desired current level in these examples) the desired waveform 200 accordingly.

After the input signal 140 is divided up into timeslices 210, controller 150 determines, for each timeslice 210, the deviation between the input signal 140 and the desired waveform 200, and then sends a command to shaper 145 to increase or decrease, if necessary, the current in each timeslice 210 to substantially compensate for the deviation. In some embodiments, controller 150 only issues a command to adjust the current in a timeslice 210 if the current deviates from that of the desired waveform by at least a threshold amount (e.g., more than approximately 5%, more than approximately 10%, or even more than approximately 20%). The threshold may be dependent upon the type of LED 125, and may be stored in storage module 170. The threshold may even be dynamically adjusted by controller 150 via monitoring of output signal 165 (as described above). FIG. 2B illustrates the resulting shaped signal 160, which substantially corresponds to the desired waveform 200 depicted in FIG. 2A. Shaped signal 160 is then converted by driver circuit 155 into output signal 165 for driving LED 125.

In some embodiments, controller 150 adjusts one or more cycles of input signal 140 (e.g., via adjustment of the timeslices thereof) based at least partially on historical data stored in storage module 170. For example, the adjustments to one or more timeslices of a previous cycle may be stored in storage module 170, and the same adjustments may be made to the corresponding timeslices of at least one subsequent cycle of input signal 140. Such history-based adjustments may obviate monitoring of every timeslice of every cycle of input signal 140; controller 150 may make the history-based adjustments stored in storage module 170, and only the timeslices of a few cycles (e.g., one of every 100, or even one of every 1000) may be monitored to base further adjustments upon. In an embodiment, after an initial “learning” period of timeslice monitoring and subsequent adjustment (and storage of such adjustment “profiles”), no further timeslices of subsequent cycles of input signal 140 are actively monitored. Rather, these subsequent cycles are adjusted, e.g., on a timeslice basis, based entirely upon the stored historical data.

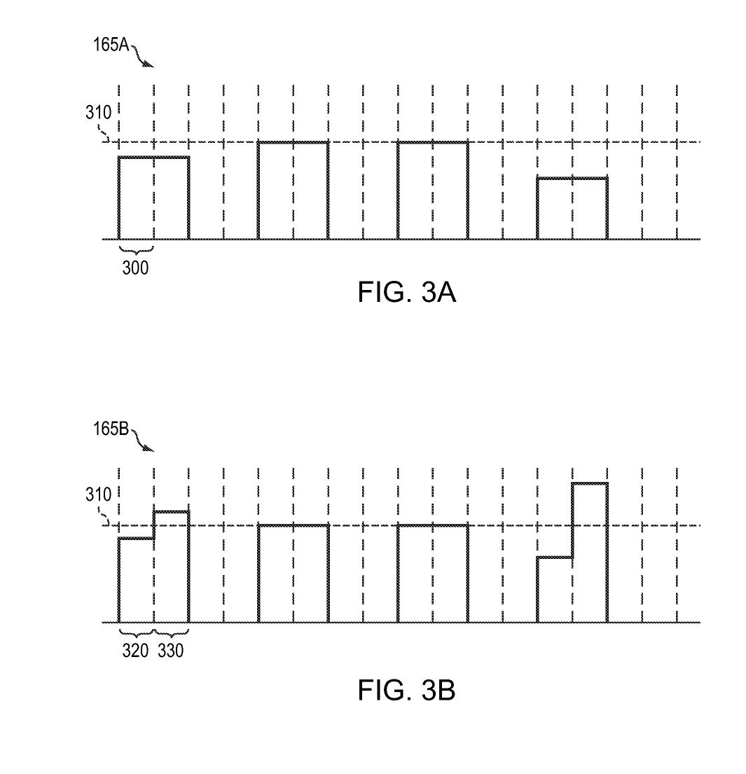

As mentioned above, controller 150 may also (or instead) monitor and control output signal 165 on a timeslice basis to ensure consistency of the current and power supplied to LED 125 during each cycle or half-cycle of power supply 105. Such consistency facilitates emission of light by LED 125 at a uniform intensity over time. FIG. 3A depicts an output signal 165A divided into a plurality of timeslices 300 per cycle (or even per half-cycle). As illustrated in FIG. 3A, output signal 165A is a modulated DC current, the intensity of which may fluctuate cycle-to-cycle. After dividing output signal 165A into timeslices 300, controller 150 determines the current level being supplied to LED 125 during a particular timeslice 300 (e.g., the first timeslice of a cycle), and integrates the current (over the time period represented by the timeslice 300) to determine the amount of power being supplied to LED 125. The controller 150 determines if the power supplied during the timeslice 300 deviates from an expected current level 310 (i.e., an expected level of current necessary to produce the power to be supplied to LED 125 per cycle). If the power supplied during the timeslice 300 is less than the expected power level 310, the controller 150 issues a command to the driver circuit 155 to increase the current level of one or more of the remaining timeslices 300 of the current cycle to compensate for the shortfall. FIG. 3B depicts an exemplary implementation, in which output signal 165A is monitored and processed as described above, resulting in output signal 165B. As shown, in one cycle, controller 150 determines that the current level supplied during timeslice 320 will result in insufficient power being supplied to LED 125 during the entire cycle. Thus, the current level in timeslice 330 has been increased (via commands issued to driver circuit 155) to compensate. Taken together, the power supplied during timeslices 320 and 330 is sufficient for operation of LED 125. Of course, the same method may be utilized to decrease the current level in subsequent timeslice(s) if the power supplied in an initial timeslice exceeds expected current level 310. As shown in FIG. 3B, during some timeslices 300, output signal 165 delivers the expected current (and thus power) level, and adjustment is not necessary.

In various embodiments, the light output intensity of LED 125 does not linearly depend on the level of current supplied to LED 125. In such cases, an algorithm and/or lookup table correlating the supplied current to light intensity for a particular LED 125 (or particular type of LED 125) may be utilized by controller 150 to properly adjust the current level in subsequent timeslices 300 in the event that an initial timeslice 300 deviates from its expected value.

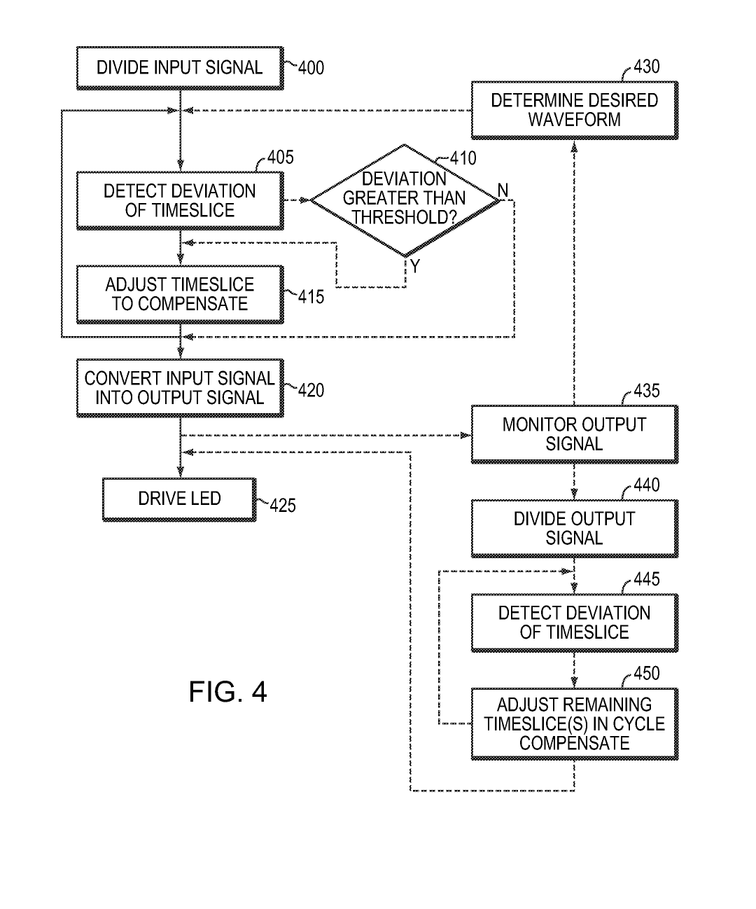

The above-described embodiments may be operated in accordance with the flowchart depicted in FIG. 4 (or a portion thereof). In a first step 400, an input signal (e.g., current) waveform is divided into timeslices. In step 405, any deviation of a timeslice (compared to a desired waveform) is detected. Optionally, in a step 410, the deviation is compared to a threshold deviation—if the deviation is greater than the threshold, the process continues to step 415, and if not, step 415 is skipped for that timeslice. In step 415, the timeslice is adjusted (e.g., current is boosted or reduced) to substantially compensate for the deviation. As shown, steps 405 and 415 are preferably repeated for each timeslice in the input signal. Then, in step 420, the adjusted input signal is converted into an output signal suitable for driving an LED, and the LED is driven in step 425.

Any of several optional steps may also be included. Before, after, or concurrent with step 400, the desired waveform may be determined in step 430. As described above, one method of determining the desired waveform is via monitoring the output signal, as shown in optional step 435. In step 440, the output signal is divided into timeslices. In step 445, any deviation in, e.g., power delivered, during a timeslice is detected. (Of course, just as in step 410, such deviation may be compared to a threshold deviation.) In step 450, any or all of the remaining timeslices in the current cycle are adjusted to compensate for the deviation in the initial timeslice. As shown, steps 445 and 450 may be repeated on a timeslice basis and/or for each cycle. The adjusted output signal is then utilized to drive the LED in step 425. In some embodiments, steps 435-450 are utilized in addition to or even instead of steps 400-420.

Embodiments of the invention also adjust, on a timeslice basis, dimmed input and/or output signals for driving LEDs, i.e., signals when a dimmer 110 is present. Such embodiments adjust the waveform timeslices to minimize the effects of noise (e.g., jitter) while preferably not altering the changes to the waveform due to the action of dimmer 110. Thus, such embodiments typically utilize structures and methods as described above, but also initially determine whether deviations in a signal are due to noise or dimming by incorporating structures and/or methods described in U.S. Ser. No. 12/965,407, filed on Dec. 10, 2010, the entire disclosure of which is incorporated by reference herein. Historical data stored in storage module 170 may include the corresponding setting of dimmer 110, and controller 150 may adjust input signal 140 based in part on such dimmer-setting data. For example, dimmer 110, e.g., a trailing-edge dimmer, may operate by cutting increasingly large portions of the falling portion of each cycle of input signal 140. Thus, any adjustments to timeslices falling within such portions are dependent on the dimmer setting, and desired adjustments to corresponding timeslices in subsequent cycles under a different dimmer setting will not necessarily be the same. Controller 150 may adjust cycles of input signal 140 based both on historical adjustment data and on the dimmer-setting data stored in storage module 170, and may even extrapolate estimated adjustments for subsequent cycles under different dimmer settings (i.e., dimmer settings not corresponding to any stored data) based on such data.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method for driving an LED lighting system, the method comprising:
dividing a power signal into timeslices;
for each timeslice, detecting a deviation in the power signal relative to an expected value;
adjusting the power signal based at least in part on detected deviations; and
driving an LED lighting system with the adjusted signal.

2. The method of claim 1, wherein adjusting the power signal comprises adjusting the power signal at each timeslice where a deviation is detected to substantially compensate therefor.

3. The method of claim 1, further comprising, for each timeslice, comparing any deviation to a threshold deviation.

4. The method of claim 3, wherein, for each timeslice, the power signal is adjusted to substantially compensate for the deviation only if the deviation is greater than the threshold deviation.

5. The method of claim 1, wherein the expected values over a plurality of timeslices correspond to a desired waveform.

6. The method of claim 5, further comprising determining the desired waveform by averaging a plurality of cycles of the power signal.

7. The method of claim 5, further comprising determining the desired waveform by (i) determining a type of the LED lighting system, and (ii) obtaining, from a look-up table, the desired waveform cross-referenced to the type of the LED lighting system.

8. The method of claim 5, further comprising determining the desired waveform by (i) monitoring an effect of the output signal on the LED lighting system, and (ii) adjusting the desired waveform based on the effect.

9. The method of claim 1, wherein the power signal is an AC current.

10. The method of claim 1, further comprising dividing the adjusted signal into timeslices.

11. The method of claim 10, further comprising, for each timeslice, (i) detecting whether a deviation exists in the adjusted signal relative to an expected value, and (ii) adjusting the adjusted signal during at least one subsequent timeslice based at least in part on detected deviations.

12. The method of claim 1, further comprising, prior to dividing the power signal into timeslices, dimming the power signal.

13. The method of claim 12, further comprising storing dimmer-setting data related to the dimmed power signal.

14. The method of claim 13, wherein the power signal is adjusted based in part on the dimmer-setting data.

15. The method of claim 1, further comprising storing adjustment data related to a selected cycle of the power signal.

16. The method of claim 15, wherein adjusting the power signal comprises adjusting at least one cycle of the power signal after the selected cycle based at least in part on the adjustment data.

17. A circuit for driving an LED lighting system, the circuit comprising:
a detection circuit for detecting deviations in a power signal compared to a desired waveform on a timeslice basis; and
an adjustment circuit for adjusting the power signal based at least in part on detected deviations therein.

18. The circuit of claim 17, wherein the adjustment circuit adjusts the power signal at each timeslice where a deviation is detected to substantially compensate therefor.

19. The circuit of claim 17, further comprising a driver circuit for converting the adjusted power signal into an output signal suitable for driving the LED lighting system.

20. The circuit of claim 19, further comprising:
a second detection circuit for detecting deviations in the output signal compared to an expected power on a timeslice basis; and
a second adjustment circuit for adjusting the output signal based at least in part on detected deviations therein.

21. The circuit of claim 20, wherein, when a deviation in the output signal is detected during a first timeslice, the second adjustment circuit adjusts the output signal during at least one second timeslice subsequent to the first timeslice.

22. The circuit of claim 17, further comprising a dimmer for dimming the power signal.

23. The circuit of claim 17, further comprising a storage module for at least one of storing the desired waveform, storing historical adjustments to previous cycles of the power signal, storing dimmer-setting data, or storing power-signal history.

24. The circuit of claim 23, wherein the adjustment circuit adjusts the power signal based at least in part on the historical adjustments.

25. The circuit of claim 17, further comprising a transformer for producing the power signal.
